(19) United States
(12) Patent Application Publication
(10) Pub. No.: US 2019/0279317 A1
(43) Pub. Date: Sep. 12, 2019

(54) Travel Planning Resource Mobile Application

(71) Applicant: Cherise Marissa Burton, Farmington Hills, MI (US)

(72) Inventor: Cherise Marissa Burton, Farmington Hills, MI (US)

(21) Appl. No.: 15/896,001

(22) Filed: Feb. 13, 2018

Related U.S. Application Data
(60) Provisional application No. 62/459,108, filed on Feb. 15, 2017.

(51) Int. Cl. G06Q 50/14; G06Q 50/00; G06Q 20/32; G06Q 20/34; G06Q 40/00; H04L 12/58

(52) U.S. Cl. CPC G06Q 50/14; G06Q 50/01; G06Q 20/3223; H04L 51/32; G06Q 40/12; H04L 51/16; G06Q 20/351

(57) ABSTRACT

This travel resource mobile application construction relates to a method and system for strategically laying out the specifications of travel within a group or on an individual bases from a remote resource. This travel resource mobile application may be installed on a mobile device through application stores, whereas the participant can assume the role of group creator/facilitator and add other users to a virtual group or be a member in another group of similar structure. The mobile application will present a secure communication source to disperse/upload travel information, execute financial transactions, upload picture albums, and communicate between other users in the group. This travel resource mobile application system will allow the configuration of facilitation of the sharing of information and finances for purpose of payments towards a trip. Participants can be added to the group using contact information, email address, social media pages, or an assigned user name.

### BRIEF SUMMARY

### Field of the Invention

The travel resource mobile application is relative to a method and system for the facilitation of the logistics, payments, and social communication involved with traveling. Various embodiments of the present travel resource mobile application relates to the engaging of users in sharing financial transactions via wireless communication.

### BACKGROUND OF THE INVENTION

The communication sector of the present time is heavily dependent upon its ability to be integrated into the most frequently used electronic device, the mobile smart phone. Wireless devices continue to break the global markets with their multifaceted device functionality. They are primarily able to feed this need on a personal and business level due to their biggest feature, the application market. They are able to engage persons in various ways via their remote systems through the linkage between various apparatuses and industries.

When engaging in the luxury of travel, it is advantageous to the participant to remain updated as to any changes in logistics of the excursion. Logistics include anything concerning living accommodations, daily itinerary plans, ground & air travel descriptions, payments made, people traveling with, etc. An example of this would be a group trip planned. Given the obvious difference in ratio between the planning times in comparison to the actual trip duration, it is easy to lose sight of important details. With this mobile app serving as a travel hub, it becomes the holder of the details. The user is able to quickly access the mobile application as a doorway to the different entities of the trip.

In any given situation when planning a trip, finances are often the hardest to get in order. More so, with the wanderlust era at an all-time high, group travel is frequent for Millennials such that there are a number of individuals pooling finances. Given such, there is a level of complexity that is seen with financial coordination. It would be very advantageous to the persons involved to be able to see an overview of what is being spent and to allocate funds to account for their portion of the trip price tag. There are a number of possible financial issues that can cause frustration such as knowing what each excursion cost, final charge for the room, individual contributions to the rental, etc. Furthermore, it becomes time consuming to send incremental payments to one trip participant and then have them withdraw finances to combine with payments from other trip participants. It would be advantageous for the user to be able to see an overview of their personal expenses, and make direct payments to a specialized virtual group account, which the creator would then withdraw funds from by conduction transactions using a virtual card.

### SUMMARY OF THE INVENTION

The functionality of this travel resource mobile travel application allows for the allocation of a group domain per the creation of the virtual trip coordinator or group creator for exclusive interaction. The trip coordinator or group creator is someone who socially chooses to take on the logistics of a specific trip. They take leadership among the persons who are participating in the trip. Once installed on your mobile device of choice, the user is then able to gain association with a specific group or remain solo. An individual can utilize this application to plan personal trips in a manner that allows them the ease of tracking down specifics and also allows them to make systematic payments towards their balance. Within their main menu, they will have a visual of all of their upcoming trips if they are engaged in multiple. A group would be more led to reference the chat log to discuss factors and then also input them in the same manner within the chat log, interactions can be conducted by typing messages or reacting to messages that others have sent using pre-assigned emotions. Pre-assigned emotions come in the form of emoji's that surface once a message is held down. It can be used for family, miscellaneous group travel, road trips, Solo excursions, etc. The user should be able to depend on the travel resource mobile application to hold all of the information relative to an upcoming adventure by land, air, or water.

This travel resource mobile application allows for to the usage of people that own a mobile smart phone. Advantageously, this allows for an advance mobile operation system with highly designed computing connectivity to execute and display mobile applications. Examples of these are IPhone, Blackberry, Windows, Androids, etc. Given such, there are a number of interfaces that come into play given these visuals.

In one embodiment, the travel resource mobile application functions as a knowledge base for access by users. Factors for input include travel itinerary, hotel, transportation, events or daily itinerary, pictures, and finances. The user should be able to click on a trip at any time and have a visual over look of the details associated with the trip. There will be a name associated with their accommodations, I.e. “Hilton Atlanta” along with details such as “single bed”, “breakfast served”, etc. Graphics of flight itinerary or boarding pass can be uploaded to the flight option. There will be a calendar option used to dictate plans while on the trip with as many details as desired. Details would include activity, time, location, attire, address, etc. photo album allows the users to share pictures within the group for purposes of keeping memories. Multiples albums can be created for organization and be access and modified by any user present in the group. A countdown option will also be present to keep you aware of days to departure. This countdown option can also be shared with friends via social media through Facebook, Instagram, Twitter, or snap chat. Once this application is used, it should eliminate the ambiguity associated with details.

In another embodiment, the travel resource mobile application presents a unique financial component that is gauged towards safety and timely payments. Line items inputted in the budget breakdown are then summed to present each traveler with a personal budget break down. From here, the payments can be made at your leisure or allowed to be taken through the auto pay method. Payments can be made using personal cards/accounts or by PayPal, Venmo, or Cashapp. This allows for smaller manageable payments leading up to the departure. The group coordinator will then serve as the collector or point of contact for finances. They will have access to the virtual account with the mass funds. Mass funds include the total amount of money submitted by each participant to date. These mass funds are uniquely housed in a temporary virtual bank account, which is generated and assigned upon request for creation of this virtual group home base. This temporary virtual account will dissolve with the group if it is ever deleted or ended. Each temporary account can make payments towards trip expenses using the assigned virtual card. This Virtual card will be usable anywhere that card information is accepted. The group coordinator will then be able to make trip expense payments using the financial information provided directly to their entities of choice. An example of this would be using the temporary virtual card provided to pay for the hotel online. This will assist with making down payments as well as final payments in the different categories without micromanaging the participants. With the group coordinator having financial responsibility, they can choose to make the mass account balance visible to everyone or to hide it. Under each line item, there is also a tab to upload graphics of the receipts associated with each payment. Dates are associated with each budget line item such that participants receive reminders if they have not submitted sufficient funds towards their portion of the budget. If at any time throughout the trip funds are loaned or borrowed between users there is the possibility for payment transactions for repaying an individual within the travel resource mobile application.

In another embodiment, the travel resource mobile application has a visual chat log. The chat log presents a social environment to allow for unity and group participation. You are able to see all of the participants through this interface. Additionally, it eases the communication prior to and while on the trip. You are able to make general comments as well as respond to specific comments with reactions or verbiage. Each user is also able to take on a specific group role/task. With such one person can be deemed “event planner”, while one chooses to be allocated as “accommodation locator”. All users possess the ability to modify content, however this allows cohesion within a group to allocate responsibilities to ease with the coordination of details and keeping the logistics up to date.

### DETAILED DESCRIPTION

### Brief Description of the Drawings

Elements of the preferred embodiments can be mixed, matched, and accessed in any specific order:

FIG. 1. Is an exemplary block diagram of the process flow of the application utilization in the mobile application;

FIG. 2. Is an exemplary block diagram of the group functionality process of the mobile application;

FIG. 3. Is an exemplary block diagram of the system information flow of the mobile network and application system integration of the mobile application;

FIG. 4. Is an exemplary schematic illustration of the login screen for the mobile application;

FIG. 5. Is an exemplary schematic illustration of the sign up screen for the mobile application;

FIG. 6. Is an exemplary schematic illustration of the Menu Screen in the mobile application;

FIG. 7. Is an exemplary schematic illustration of a user profile screen in the mobile application;

FIG. 8. Is an exemplary schematic illustration of the profile settings screen in the mobile application;

FIG. 9. Is an exemplary schematic illustration of the Support & Feedback screen in the mobile application;

FIG. 10. Is an exemplary schematic illustration of the Invite Friends screen in the mobile application;

FIG. 11. Is an exemplary schematic illustration of the Trip group creation screen in the mobile application;

FIG. 12. Is an exemplary block diagram of the group creator's functionality in the mobile application;

FIG. 13. Is an exemplary schematic illustration of an individual group home page & menu in the mobile application;

FIG. 14. Is an exemplary schematic illustration of the group album screen in the mobile application;

FIG. 15. Is an exemplary schematic illustration of a user's list of upcoming trips screen in the mobile application;

FIG. 16. is an exemplary schematic illustration of the Activity Creation screen for the itinerary in the mobile application;

FIG. 17. is an exemplary schematic illustration of a specific trip's itinerary/agenda screen in the mobile application;

FIG. 18. Is an exemplary schematic illustration of a specific trip's itinerary detail expansion screen in the mobile application;

FIG. 19. Is an exemplary block diagram of the virtual itinerary/agenda process function in the mobile application;

FIG. 20. Is an exemplary schematic illustration of the member log screen in the mobile application;

FIG. 21. Is an exemplary schematic illustration of the member log screen for adding to a group in the mobile application;

FIG. 22. Is an exemplary schematic illustration of a an active chat log screen in the mobile application;

FIG. 23. Is an exemplary block diagram of the group chat functionality process in the mobile application;

FIG. 24. Is an exemplary schematic illustration of the message center screen in the mobile application;

FIG. 25. Is an exemplary schematic illustration of a Create Budget Item screen in the mobile application;

FIG. 26. Is an exemplary schematic illustration of the Budget Overview screen in the mobile application;

FIG. 27. Is an exemplary schematic illustration of the Budget Expansion Page screen in the mobile application;

FIG. 28. Is an exemplary schematic illustration of Budget History Screen in the mobile application;

FIG. 29. Is an exemplary schematic illustration of the Personal Budget View screen in the mobile application;

FIG. 30. Is an exemplary schematic illustration of the Payment Screen for both individual and budget payments in the mobile application;

FIG. 31. Is an exemplary schematic illustration of the Add Cash screen in the mobile application;

FIG. 32. Is an exemplary schematic illustration of the Virtual Card screen for both individual users and each group in the mobile application;

FIG. 33. Is an exemplary block diagram of the virtual payment function process for internal payments in the mobile application;

FIG. 34. Is an exemplary block diagram of the virtual payment function process for external payments using the mobile application;

### DETAILED DESCRIPTION OF THE PREFERRED EMBODIMENTS

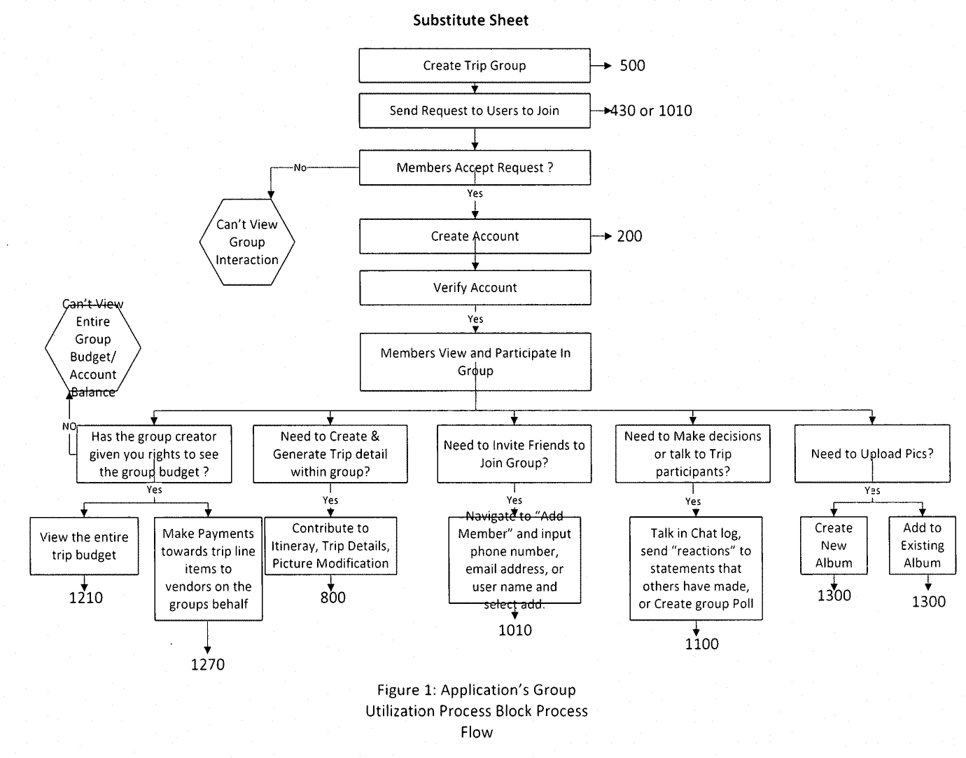

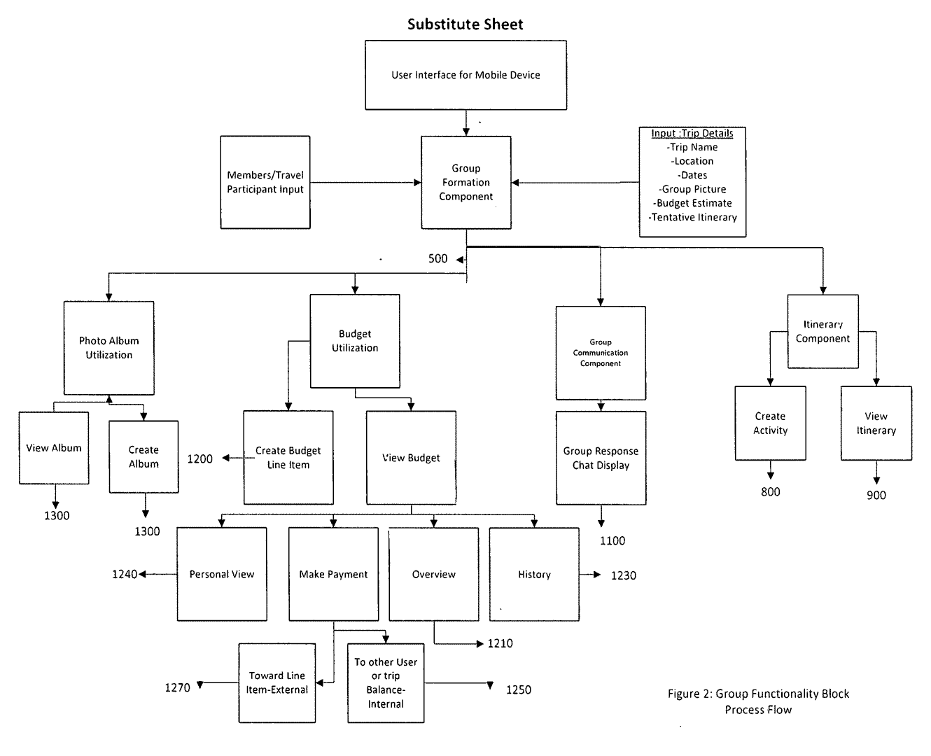

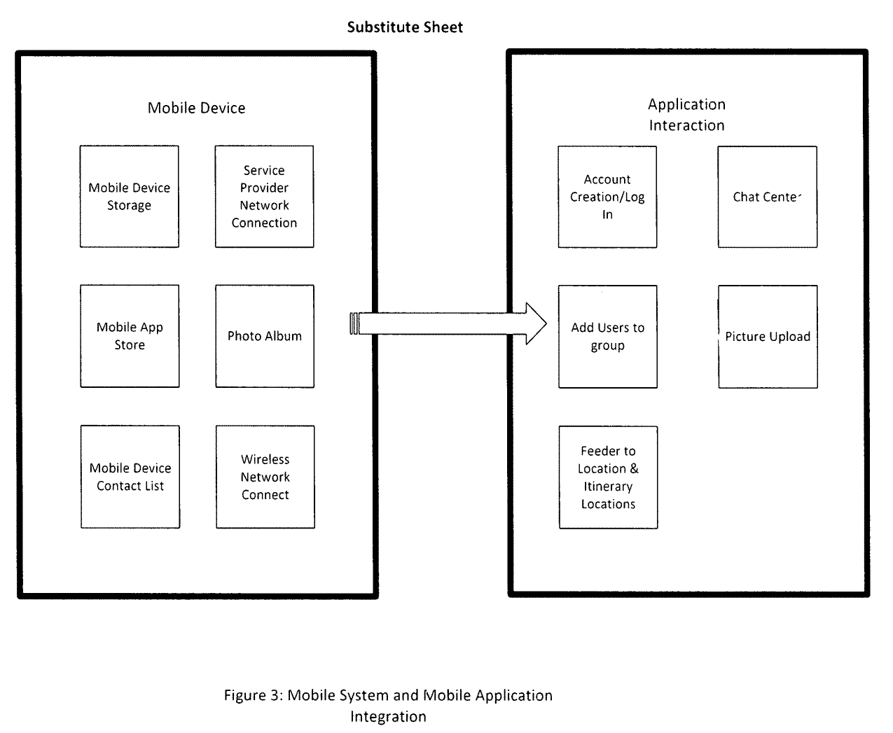

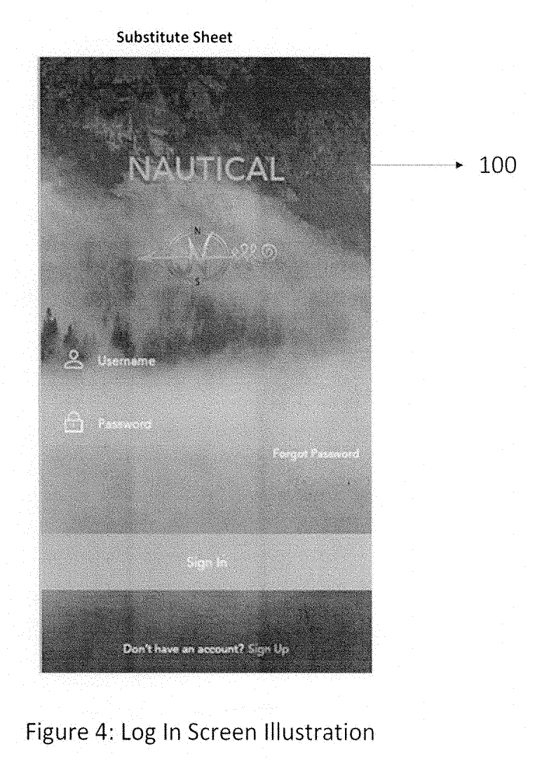

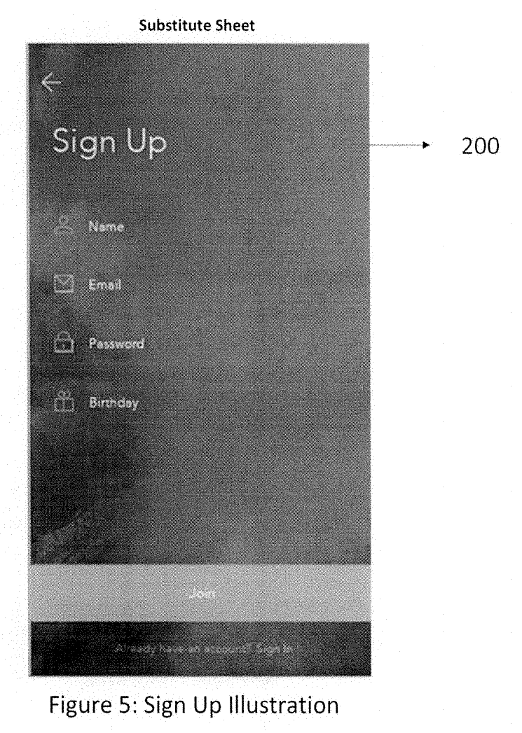

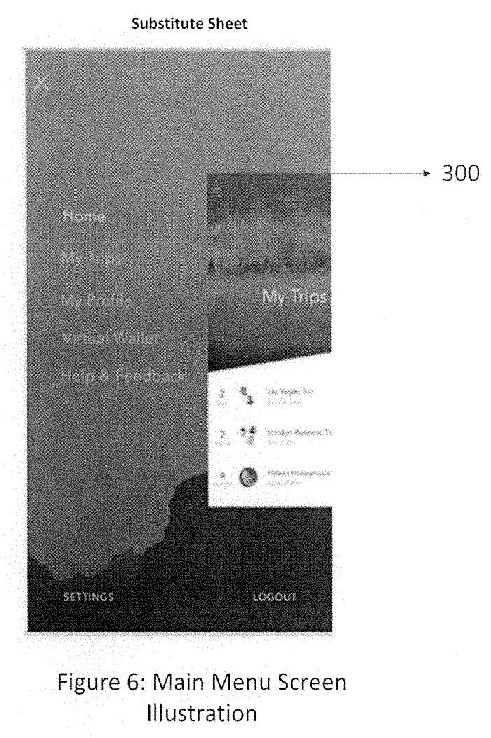

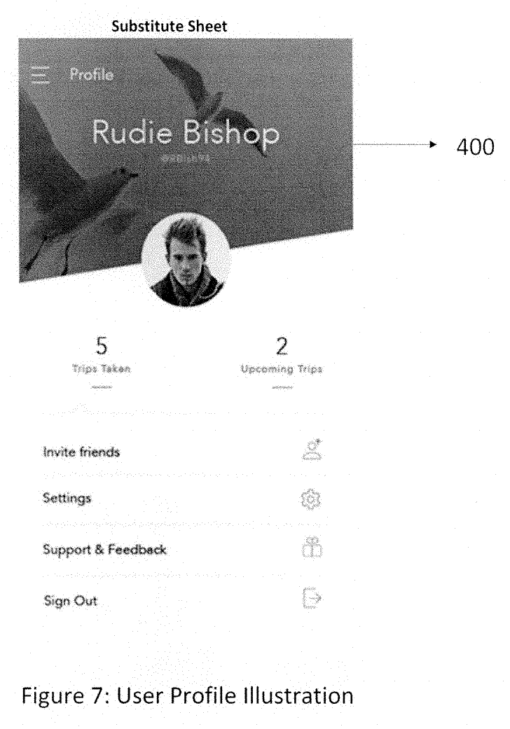

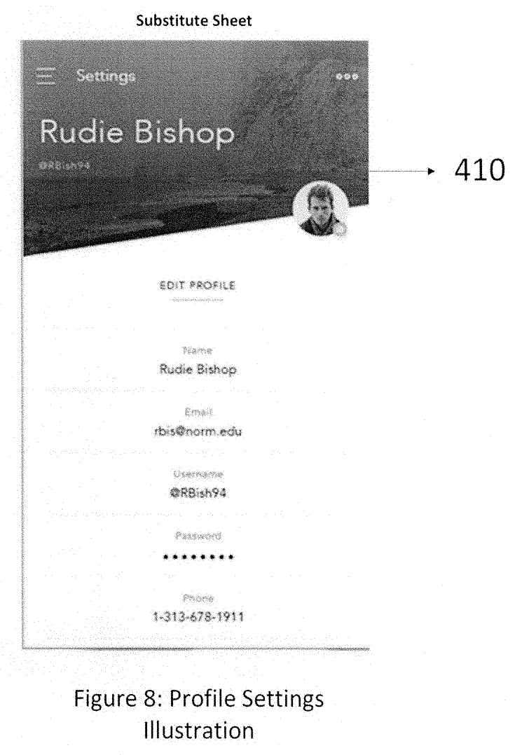

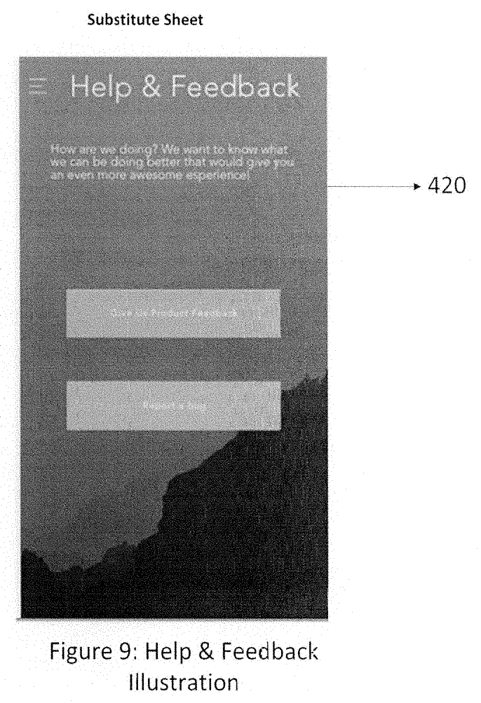

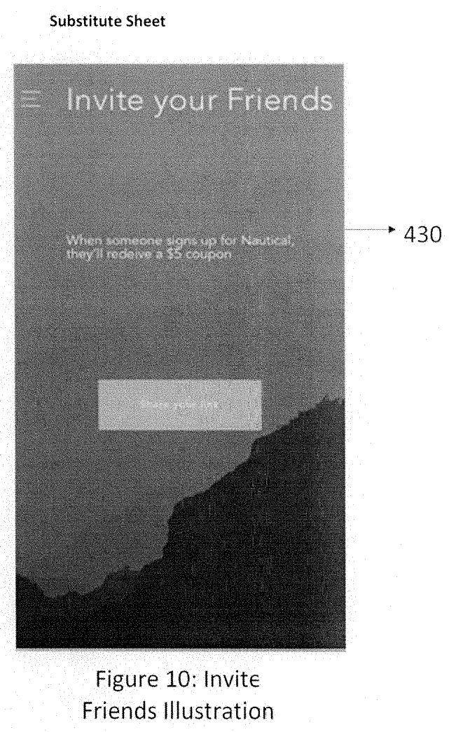

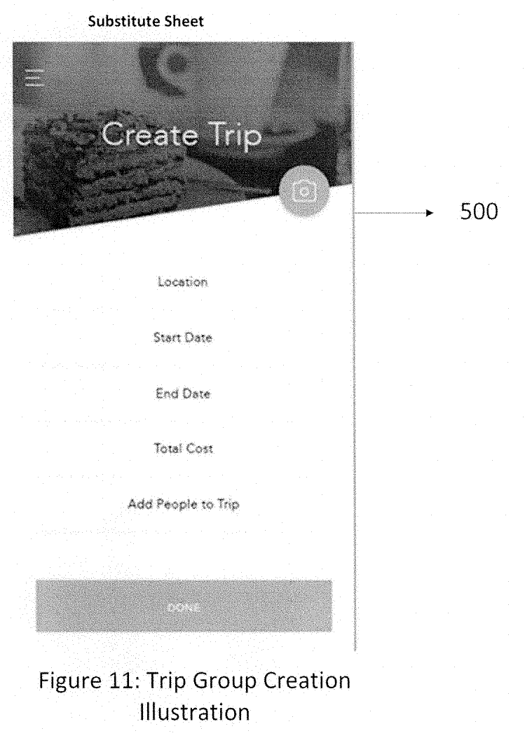

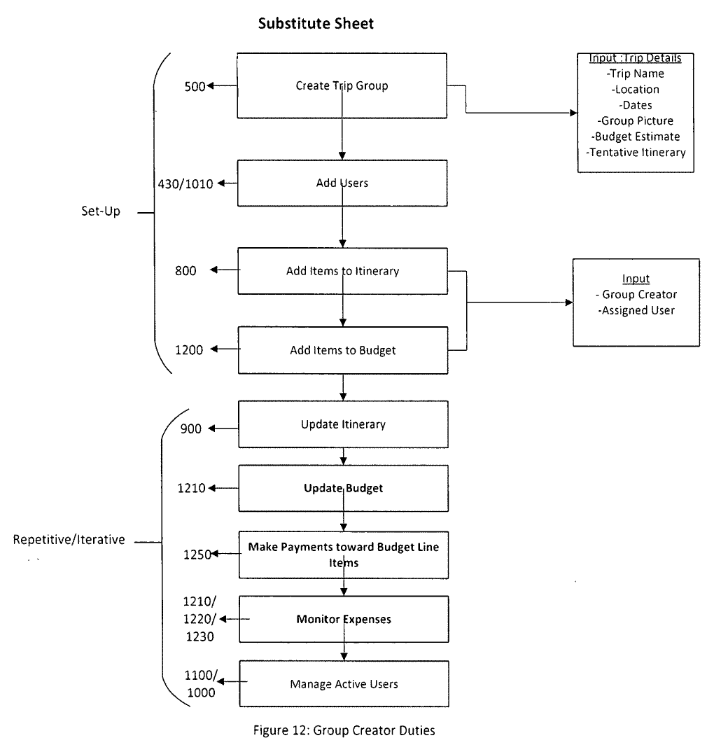

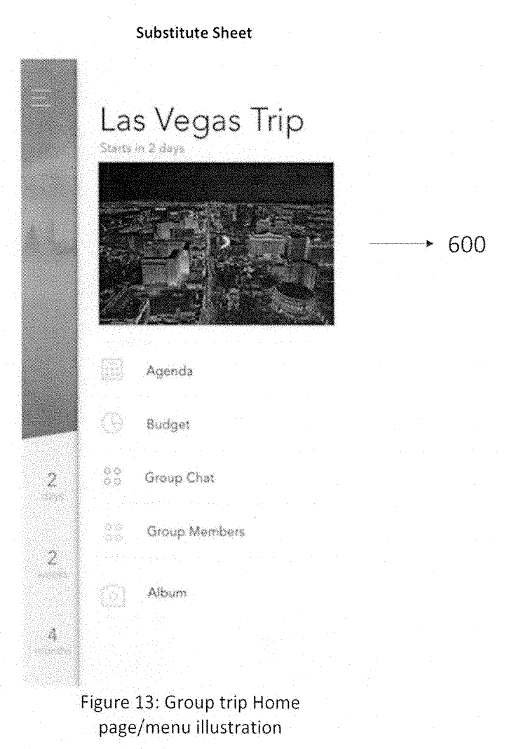

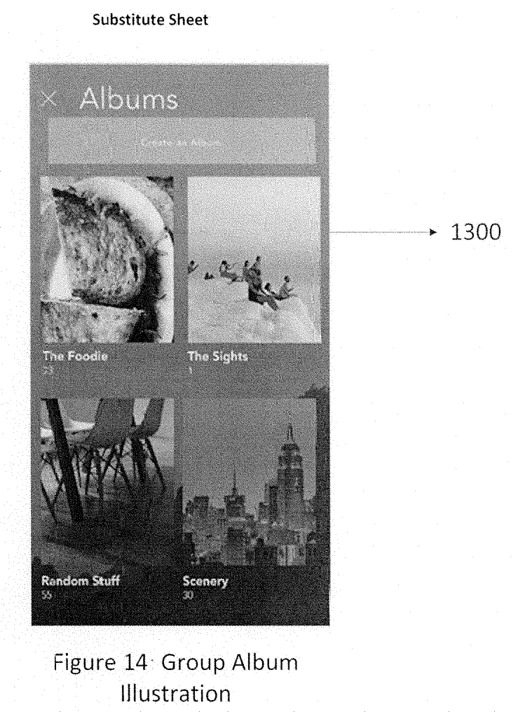

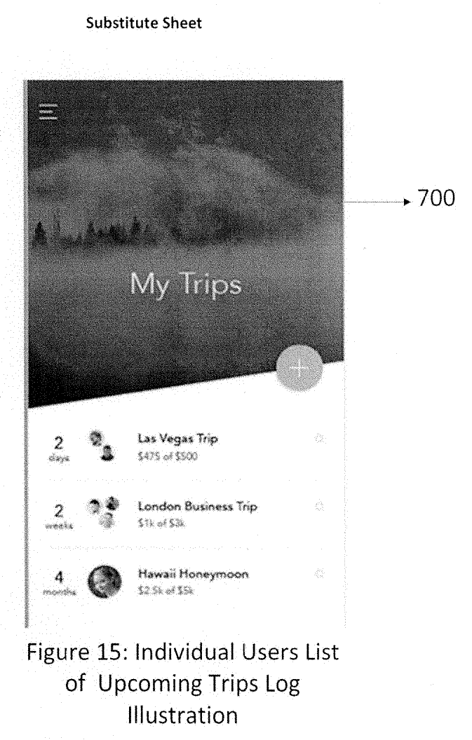

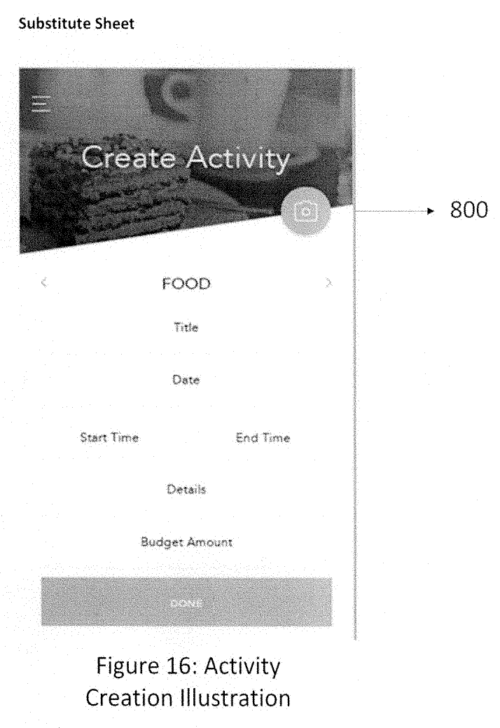

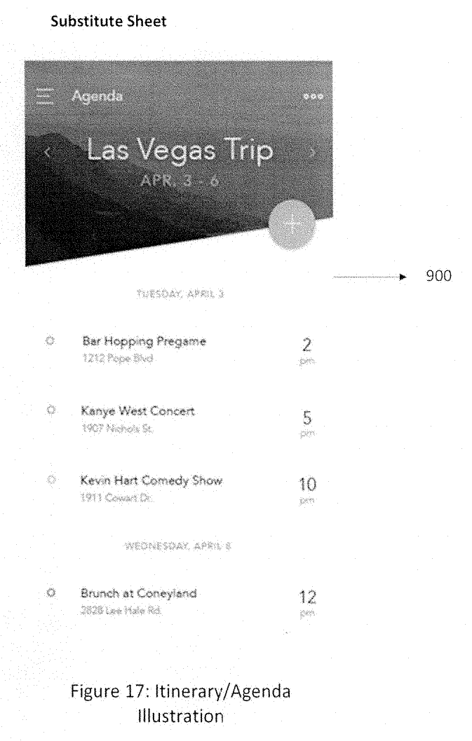

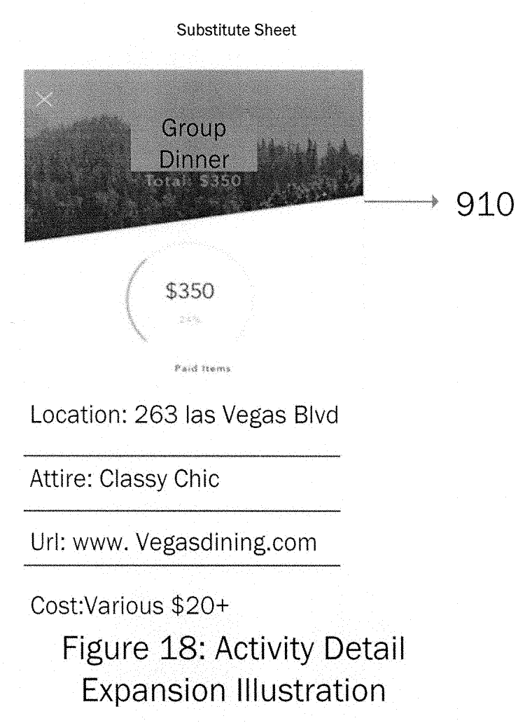

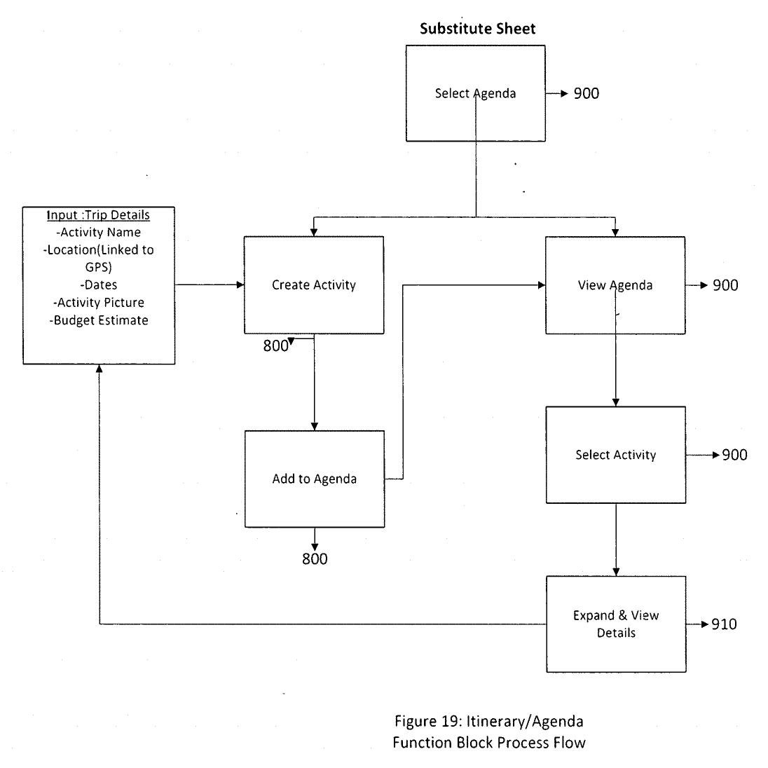

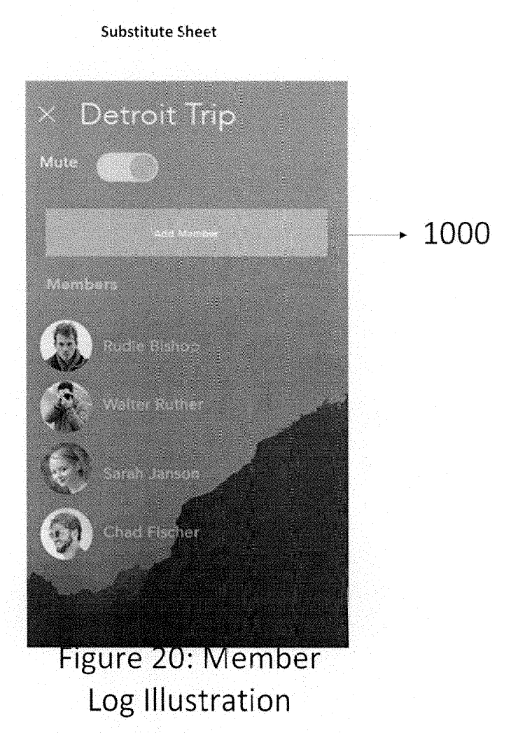

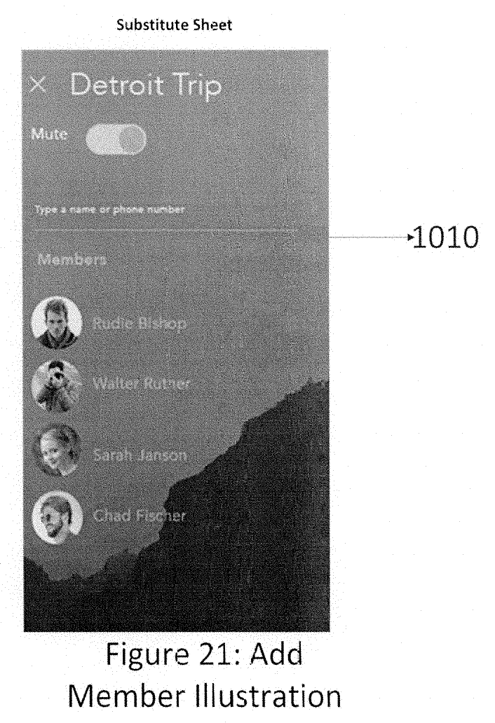

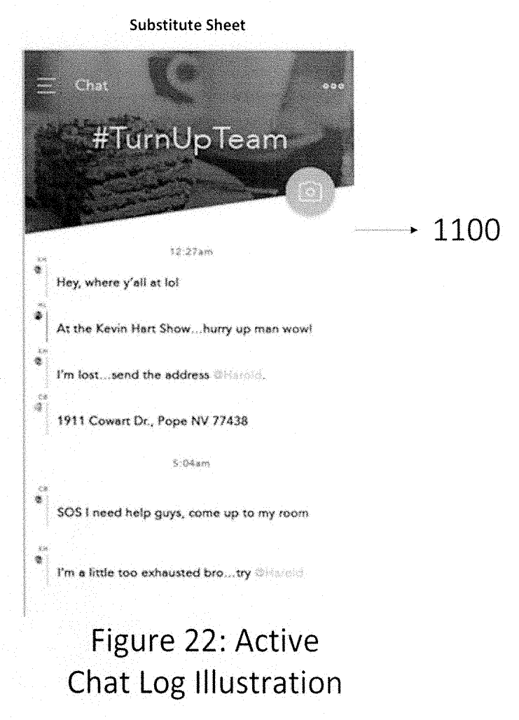

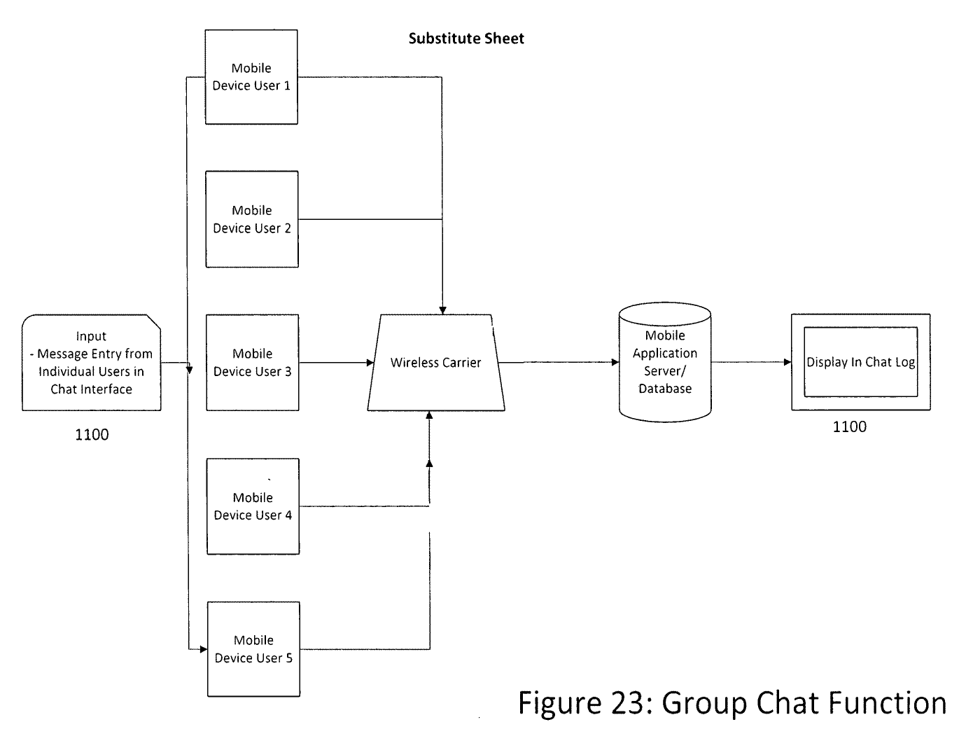

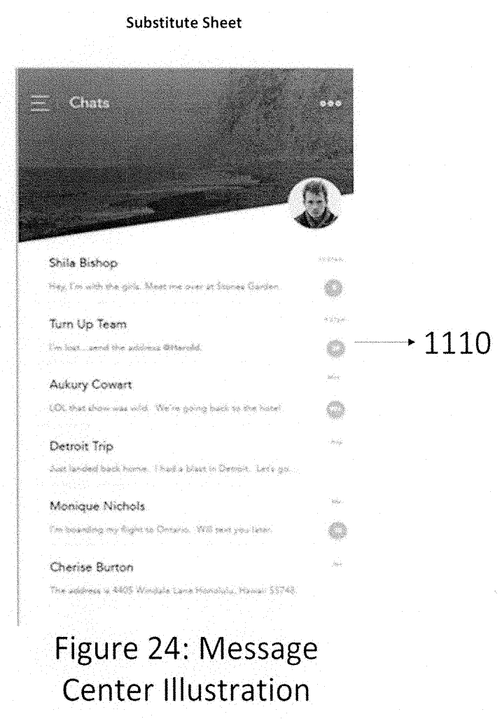

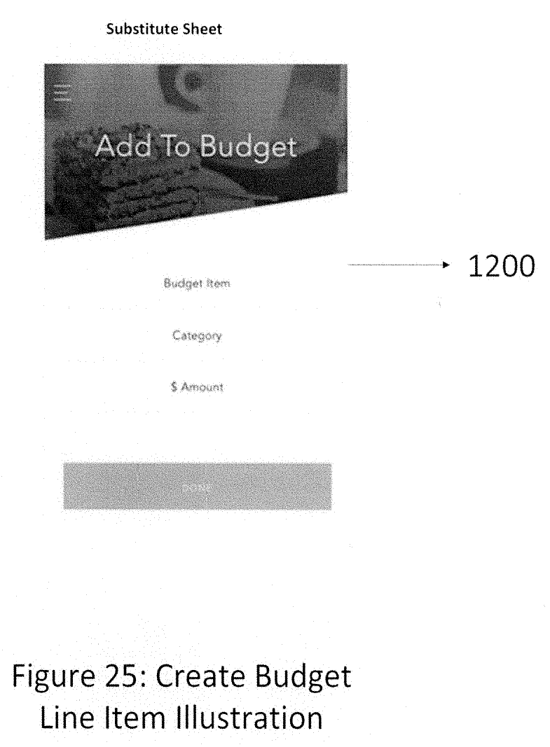

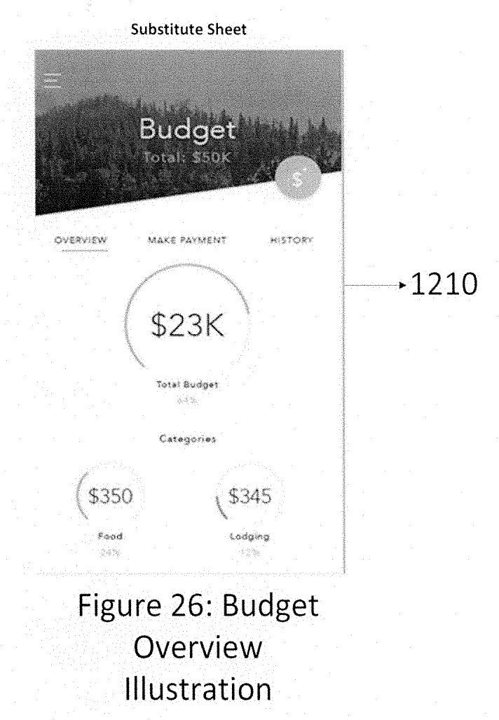

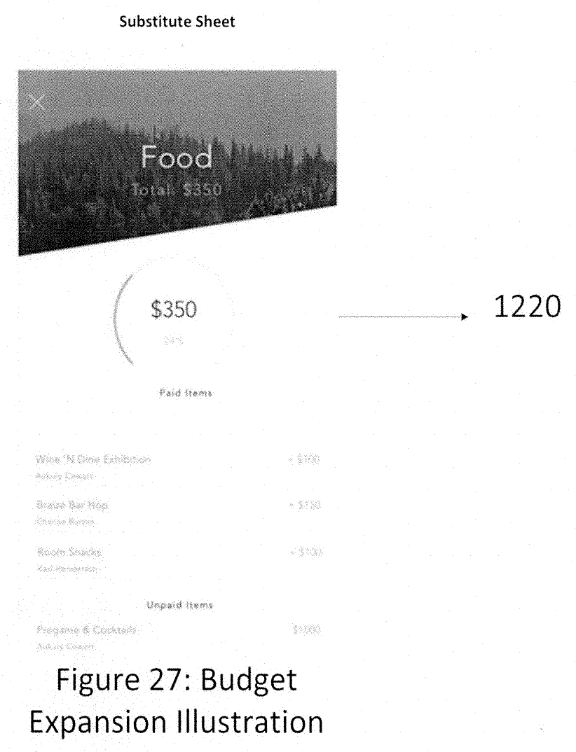

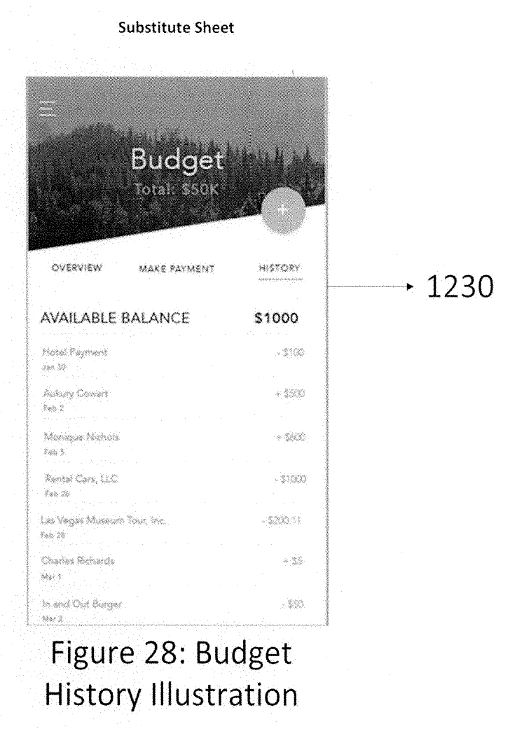

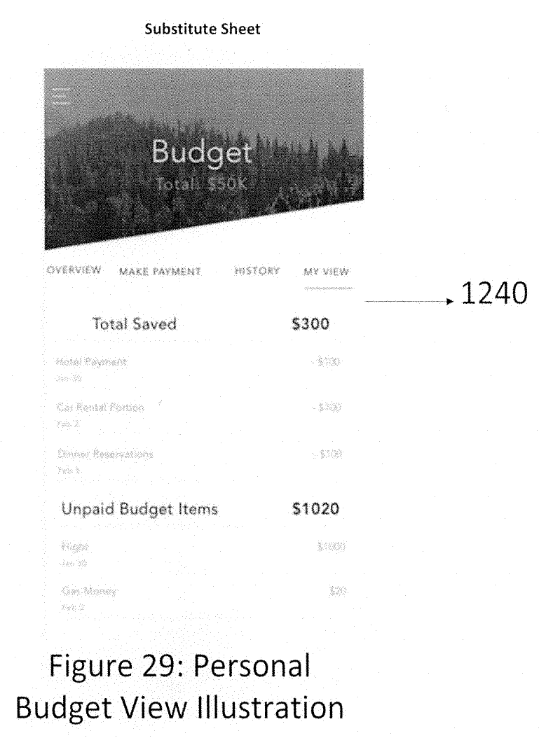

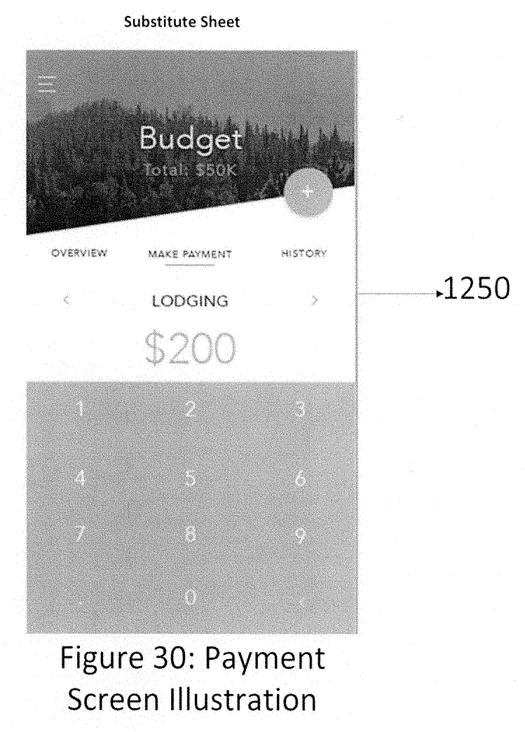

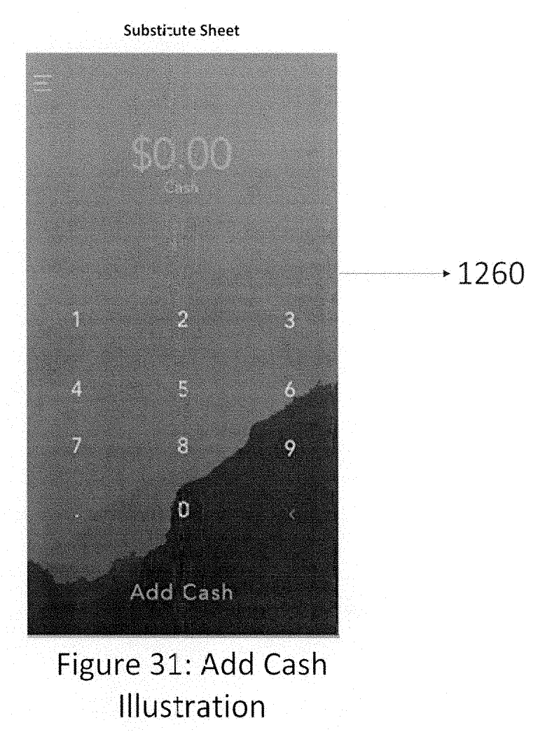

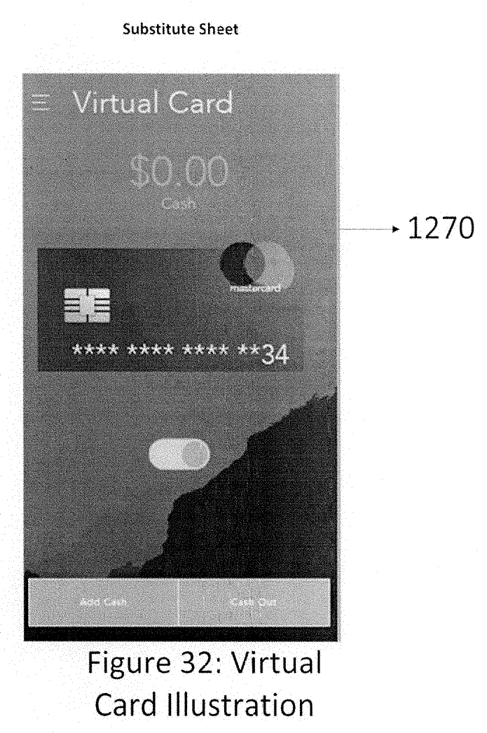

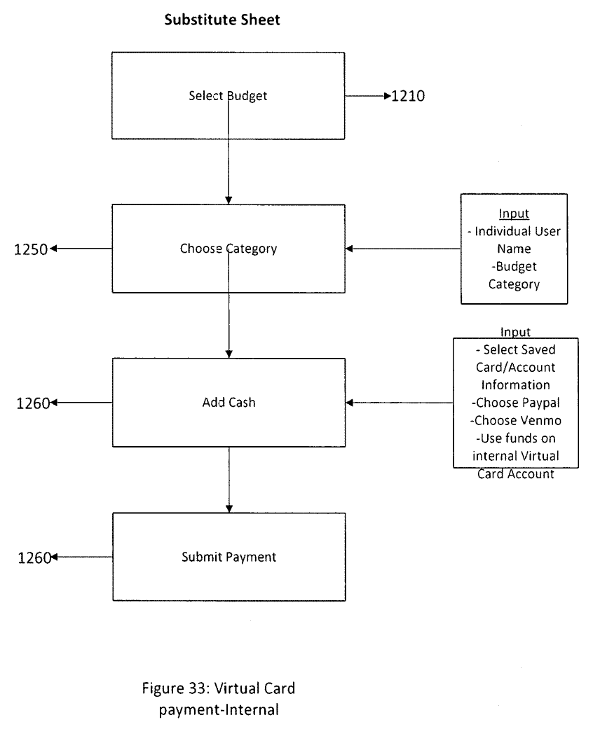

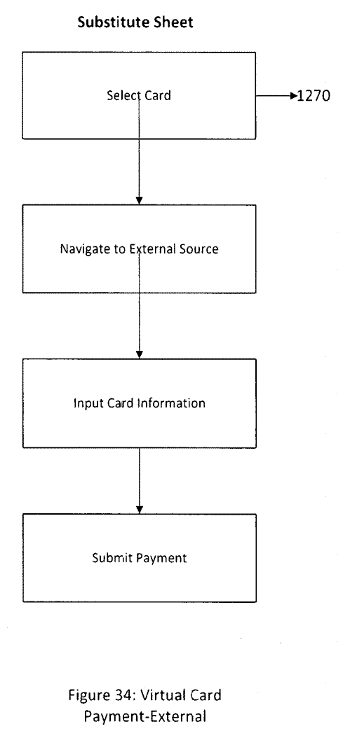

The figures will be described in connection to the aforementioned method and system as a mean of illustrative understanding. This is not for limiting purposes.
(1) In reference to FIG. 1, illustrated is an exemplary block diagram of the Application's Group Utilization Process in the mobile application. The process includes creation of a group 500. This group will serve the purpose of being a virtual group resource for housing the details associated with the planning process of the group trip. Once it is created, details can be added or modified as time progresses. This initial group creation serves as a template. For example, as a group creator the idea surfaces to travel to a specific location. They will open the travel planning resource mobile application and select the group creation button 500. They will input preliminary information such as “US Virgin Islands” & “January 6-12” in the respective details. However, the preliminary information that is inputted is not limited to this. It can be as detailed as the group creator chooses. Upon creation of the group 500, the full functionality of the group features for budget, itinerary, album, etc. become accessible to the group creator.
(2) The group/trip creator is a role that can be assumed by each user as many times as desired. A group/trip creator is simply someone who initiates the creation of the group for purposes off trip planning. They become the controller of the finances by default and can then decide if they want the group account to be visible to the group or not.
(3) Next, this process includes sending a Request 430 or 1010 to contacts to join the respective group. This request to join 430 or 1010 may be received in a text or email form. If the recipient chooses to ignore the message, they will not be able to view the group or participate in the interactions. If the link is selected it will navigate the recipient to the travel resource planning mobile application. If they are presently users with a profile it will directly navigate then to the respective group. If they are not registered users, it will give them the option of creating an account 200. Once the Create account 200 is executed, it will take them through a verification process. Once this is completed, members will gain access to view and participate in the travel group.
(4) The group/trip participant is a role that can be assumed by each user as many times as desired. Once the group/trip creator sends a request and it is accepted, the group domain becomes visible. The group/trip participant is then able to extend the request to join group 430 to other possible participants. Additionally, the group/trip participant is then able to make modifications to the group through the itinerary 800 and photo album 1300. Once given the right by the group/trip creator the group/trip participant is also able to make modifications to or disperse finances from the group budget 1270.
(5) In reference to FIG. 2, illustrated is an exemplary block diagram of the Group Functionality Process in the mobile application. The process is initiated when the user engages with the interface of their mobile device. The user is able to create a Group 500. This is includes modifications to add member option 430, Trip Details 600, Budget Estimate 1200, & Tentative Itinerary 800.
(6) Next, the process includes Photo Album Utilization. This includes Creating Albums 1300 or Viewing Albums 1300. An example of this is the receiving of images while on the trip previously mentioned to the US Virgin Islands. Images are easily scrambles in an inclusive gallery, which can be very complicating. A group user is able to create a unique album to organize the activities that they participated in while on this trip. An example of this may include “Snorkeling at Buc Island” or “Rain forest tour”. Each user is able to view and add to any of the albums that are created by other users in the group.
(7) Next, the process includes Budget Utilization. This allows the facilitation of the group funds internally within the travel resource mobile application system and expenditures to be controlled through the group budget interface. This includes creating a Budget Line item 1200. Creating a Budget Line item 1200 includes selecting a category for the respective expense, inputting the expense's unique description, and inputting the cost that will be associated with it. Examples of categories may include transportation, lodging, food, or activities. If the desired category is not in the generated categories, the user has the option to manually enter an alias to represent the category of interest. Once the category is selected, a specific description slot will allow for a more detailed naming scheme. An example of such an input would include the Food Category with a description such as “Dinner at the Marina—$60”. There is no limitation as to the number of line items that can be added. This is at the discretion of the group creator for ease of the users understanding the payments that are due.
(8) In reference to budget utilization, the process includes a visual over view of the budget, which is a direct output of Create Budget Line Item 1200. The View Budget option allows for making a Payment to the budget, Budget Overview 1210, View of History 1230, & Personal View 1240. Funds for payment are added to the user's account using Add Cash 1260. Add Cash 1260 can come in the form of an account, Debit Card, Credit card, or 3^{rd} party payment source such as PayPal, Venmo, or Cashapp.
(9) In reference to budget utilization, the Process allows for making payments internally 1250 within the travel resource mobile application system. Making Payments internally 1250 can take a number of forms. Making Payments internally 1250 can be to another user. For example, a user covered your beverages during a night on the town when you were low on cash. Making Payments 1270 allows you to select the user and refund the money that has been spent. This will go to the users personal Virtual Card 1270 and Virtual account 1270, which they can withdraw on their own time, or use through their Virtual Card 1270. Making Payments internally 1250 can also be used to make payments towards the user's personal budget 1240. The total personal balance overview 1240 states this. The user can select the frequency of the payments to be single or automated. All payments made by users internally 1250 accumulates in the group's assigned temporary Virtual account, which can be accessed using the group's Virtual Card 1270.
(10) In reference to budget utilization, the process allows for making payments externally 1270 to vendors, which the group is using for facilitating their travel arrangements. Making payments externally 1270 allows the group creator or assigned users to access the group's virtual card and virtual account. The group creator's profile includes the setting to hide or make the budget overview visible to all group participants. For example, the group to the US Virgin Islands is comprised of a large group of users that you have not directly added to the group. In a situation such as this, participants may be lazy in regards to making payments if they are able to see that the account has available funds. Ultimately, other participant's funds will be depleted absorbing the cost of the users that are taking advantage. Turning off the visibility of the budget will ease in preventing this situation. In another scenario, a small intimate group of friends is participating in this trip. In this scenario, the trust levels are higher and the visibility of the budget overview 1210 is not a problem. In addition, the group creator's settings includes the option to make the budget and Virtual Card accessible to identified group participants. For example, a payment is due and due to various reasons, the group creator is unable to delegate time within their schedule to address the payment in time to avoid additional charges. Assigning a user access to the budget allows them to balance the tasks included with successful trip execution. Making payments externally 1270 would allow the group creator or assigned user to make official payments towards trip expenses. For example, the trip to the US Virgin Islands is 2 months away and the villa down payment is due. Users have made payments internally 1250 towards their personal balance. These funds have accumulated in the Virtual account and now totals $12,000. The group allocation for accommodation shows $6,000 in the budget overview 1210. The down payment is $1,500 and the budget overview 1210 shows that we have accumulated the funds. The group creator is then able to navigate to Make Payments toward line items external 1270 and preview the Virtual Card Information 1270. From there the group creator or assigned user is able to navigate to the accommodation's payment system and input the card information. Once the payment is submitted, it will reflect in the Budget history 1230 as a charge and the reduction will be seen as a reduction on the Budget Overview's balance 1210.
(11) In reference to budget utilization, the process allows for a budget over view 1210. The budget overview 1210 shows each category and the expected cost. This view is only available for the group creator and the user that they have allowed access. This ensures the safety of the finances. The overview 1210 shows an overview of each category respectively.
(12) In reference to budget utilization, the process allows for a History View 1230. The History View 1230 shows all of the transactions that have been executed using the respective payment systems whether internal 1250 or external 1270.
(13) Next, the process allows for Group communication. Group communication takes the form similar to any multi member chat log. The group communication has no specific flow or precedence. The communication is seen in the group response chat display 1100. Members are able to input independent messages, respond to previously made statements directly, or react to statements using emoji.
(14) Next, the process allows for an Itinerary Component. This Itinerary component is a compilation of the events or activities that the group wishes to participate in while on the trip. The itinerary component allows for Activity Creation 800 and View Itinerary 900. Activity Creation 800 allows the addition of a line item to the present Itinerary. A unique title is optional as well as the details associated with the activity. For example, “Breakfast on the beach, 9:00 am, casual attire”. The View Itinerary 900 option is a direct output of the compilation of Activity Creation Inputs 800. The details are not limited to the stated. Any user is able to make modifications to the itinerary. There is no approval needed.
(15) In reference to FIG. 3, illustrated is an exemplary process of a Mobile System and Mobile Application Integration in the mobile application. A mobile smart device being the hardware for use of the travel resource mobile application utilizes various components of the device to function. The components include the Mobile Device Storage, Mobile Application store, Mobile Device Contact list, Photo Album, Service Provider Network Connection and Wireless network connection. This feeds to the Application interaction to facilitate the use of Account Creation/Log In 100/200, Chat Function 1110, Add users to group 1010/430, Picture Upload 1300, & Feeder to location for Itinerary items 600.
(16) In reference to FIG. 4, depicted is an exemplary illustration of a log in screen 100 of the mobile application. The login screen 100 includes username field, a passcode field, a forgot password button, a sign in button, and a sign up button. The username field may be an assigned name or selected username or any user of the mobile application. This username will uniquely identify a user of the mobile application or service and may be any number of letters, characters, numbers, etc. The passcode field is generated by the user to be synched with the username. The passcode field may be letters, numbers, characters, etc. Once the user name and password are inputted in the appropriate fields, the Sign In button is selected. This will navigate the user to the Main Menu Screen 300. The forgot password button is a link that allows the regeneration of a new password in the event of forgetting the present password. This forgot password button would redirect you to a page for input of user verification information. The user verification information is simply the email used for subscription as well as a series of “secret questions” which the user would have selected and answered upon creation of the account.
(17) In reference to FIG. 5, depicted is an exemplary illustration of a Sign up screen 200 of the mobile application. The Sign Up screen 200 may include a name field, an email field, a password field, a birthday field, a join button, and a Sign In button. This screen may either appear before or after the Log In screen 100. An example of this is if the user is a new user, the sign up screen 200 will come before the log in 100.
(18) In reference to FIG. 6, depicted is an exemplary illustration of a user's Main Menu Screen 300 in the mobile application. The Main Menu screen 300 may include a Home Button 300, My Trips Button 700, My Profile Button 400, Virtual Wallet Button 1270, Help & Feedback Button 420, Settings Button 410, & Logout Button.
(19) In reference to FIG. 7, depicted is an exemplary illustration of a user profile 400 that is created because of FIG. 5, Sign up Screen 200 in the mobile application. The User Profile 400 may present the user with personal profile information and preferences. The User Profile may include number of trips taken, number of upcoming trips, invite friends button 430, settings button 410, help & feedback button 420, Home Button 300 and a sign out button.
(20) The Number of trips taken may provide the user with a physical number of trips that may have been taken in the past based on the log that is generated of groups that they are present in with dates for travel that have passed.
(21) The Number of Upcoming Trips taken may provide the user with a physical number of trips that are projected for the future based on the list of groups that they are present in with dates for travel that are in the future.
(22) The invite Friends button 430 may allow users to send requests to friends to download the mobile application and begin to use it. Once they have created profiles they are then able to participate in the functionality of the mobile application from a group creator or group participant role.
(23) The settings button 410, may allow the user to modify the profile information that is set, such as the picture, Name, Email, Username, password, phone number, etc.
(24) The help & feedback button 420, may allow the user to fill out a questionnaire in reference to the functionality of the mobile application and concerns. This may also allow the generating of ratings for this mobile application that may be visible by future users.
(25) The Home Button allows the user to navigate back to the Main Menu Screen 300 depicted in FIG. 6.
(26) The Sign Out button may allow the user to exit the personal profile. This may redirect the user to FIG. 4, Log In Screen 100.
(27) In reference to FIG. 8, depicted is an exemplary illustration of the settings 410 in the mobile application, which may provide the users with the option of making changes to their own profile, such as the picture, privacy settings, Name, Email, username, password, phone number, etc. Additionally, Home Button 300 may be included, which will return the user to the main menu screen 300.
(28) In reference to FIG. 9, depicted is an exemplary illustration of the Help & Feedback Screen 420 of the mobile application. The Help & Feedback Screen 420 may include a button for Product feedback, a button for reporting issues, and Home Button 300. The Home Button will return the user to the main menu screen 300 of the application.
(29) The Product Feedback button may allow the user to provide the travel planning resource mobile application with insight into their personal user experience.
(30) The Report an Issue button may allow the user to report issues or glitches that they may be experiencing while using the travel planning resource mobile application.
(31) In reference to FIG. 10, depicted is an exemplary illustration of the Invite your friends' screen 430 in the mobile application. The Invite your friends' screen 430 includes a Share your link button and Home Button 300. The Home Button will return the user to the main menu screen 300 of the travel planning resource mobile application.
(32) The Share your link button allows the users to send friends requests to sign up for access to utilize the travel planning resource mobile application.
(33) In reference to FIG. 11, depicted is an exemplary illustration of the Create Trip Screen option 500 of the mobile application. The create trip screen 500 may include a group profile picture upload button, Location field, Start Date field, End date field, total cost field, add people to trip field, Done button, and Home Button 300. The location field is inputted by the trip/group creator as the desired location to display in the group for travel. The Start Date and End Date are the assigned dates for travel for the group to the selected destination. The total cost states the overall expected finances that would be needed to allow successful travel or the group or individual. The Add person 430 to Trip field allows the selection of persons to received access to the group for the purpose of travel coordination. For example Location: Tortola, British Virgin Islands, Dates: June 5-7, Total Cost $6,000. A line item of this Trip will be visible in the log presented in FIG. 15. The Home Button will return the user to the main menu screen 300 of the travel planning resource mobile application.
(34) The group profile picture upload button may provide the user the ability to select a picture to serve as the group's visual graphic. The particular picture can be uploaded from the user's mobile devices picture album as seen in FIG. 3 of the mobile system and mobile application integration process flow.
(35) In reference to FIG. 12, illustrated is an exemplary block diagram of the group creator duties for the mobile application. The process includes tasks to set up which include Create Trip Group 500, Add Users 430/1010, Add Items to Itinerary 800, and Add Items to budget 1200. Iterative maintenance tasks include update Itinerary 900, Update Budget 1210, Make Payments towards budget line items 1250, Monitor Expenses 1210/1220/1230 and Manage Active Users 1100/1000.
(36) Iterative tasks are those that are expected to be constantly modified during the life of the travel group. For example, the trip to the US Virgin Islands planning phase has been initiated. As the Group utilizes the chat and makes decisions some coupons were found for activities however, the trip dates may need to be modified to take advantage of them. The group decided to modify the dates to facilitate this. Participants manually change these inputs.
(37) In reference to FIG. 13, depicted is an exemplary illustration of a Group Trip Menu 600 in the mobile application. The Group Trip Menu 600 may include an Agenda Button, Budget Button, Group Chat Button, Group Members Button, Album Button, Settings Button, and Home Button 300.
(38) The Agenda Button will allow the user to navigate to the Agenda/Itinerary Screen 800.
(39) The Budget Button will allow the user to navigate to the Budget Overview 1210.
(40) The Group Chat Button will allow the user to navigate to the Group Chat 1100.
(41) The Group Members Button will allow the user to navigate to the member's log 1000.
(42) The Album Button will allow the user to navigate to the Albums 1300.
(43) The Settings Button will allow the user to navigate to the settings. 410.
(44) The Home Button will return the user to the main menu screen 300 of the travel planning resource mobile application
(45) In reference to FIG. 14, depicted is an exemplary illustration of The Group Album 1300 in the mobile application. The Group Album may include a create album button, buttons for all of the pre-existing albums, and Home Button 300. Users are able to upload pics to pre-existing albums as well as create new albums. The Home Button will return the user to the main menu screen 300 of the travel planning resource mobile application
(46) In reference to FIG. 15, depicted is an exemplary illustration of a User's My Trips log 700 in the mobile application. The My Trips screen 700 may include an Add Trips button and Home Button 300. It may also present the user with a list of the upcoming trips. For example, you are presently participating in four (4) groups within the travel planning resource mobile application to Aruba, South Africa, New York, and St. Martin. A list will be seen of these trips from closes travel date to furthest travel date. Additionally, the user may be able to see a countdown of the days/months to the trip as well as the amount that they have paid towards the upcoming trip in comparison to the total balance. Selecting any of the trips will navigate you to FIG. 13 Group trip home 600. Selecting the Home Button will return the user to the main menu screen 300 of the travel planning resource mobile application
(47) The Add Trip button may provide the user with the ability to create another trip listing for their log. The selection of this button may take you to FIG. 11 trip Group Creation 500.
(48) In reference to FIG. 16, depicted is an exemplary illustration of the Create Activity screen 800 in the mobile application. The Create Activity Screen may include an Activity picture upload button, Category selection button, Title field, Date field, Start time field, End time field, Details field, budget amount field, done button, and Home Button 300. The title field is inputted by the trip/group creator as the desired activity to display in the group for listing in the itinerary. The Start Time and End Time are the assigned time slots for the activity that the group will be participating in. The total cost stated to participate in the activity. The Details field may be inputted by the activity creator and used to detail anything that may be helpful for attending the listed activity. For example, the details may include something like “Sea Trekking, Location: 23484 Exotic Drive, Attire: Casual, Long wait time estimated”. Therefore, the passengers attending the activity will have the ability to figure out their ETA and additional time to ensure that they are able to make it on time and are properly dressed for the event. Selecting the Home Button will return the user to the main menu screen 300 of the travel planning resource mobile application.
(49) The group profile picture upload button may provide the user the ability to select a picture to serve as the activity's graphic. The particular picture can be uploaded from the user's mobile devices picture album.
(50) The Category Selection Button may present the user with a number of categories such as food, shopping, excursion, etc. to allow the user to categorize their events.
(51) In reference to FIG. 17, depicted is an exemplary illustration of an Itinerary/Agenda screen 900 in the mobile application. The itinerary screen may include a list of items from the Create Activity Screen 800 and Home Button 300. The lists of items on the itinerary are listed by daily occurrence and time of day. Each activity on the list can be selected for a breakdown of the details associated. Selecting an activity may take the user to FIG. 18, Activity Detail Expansion Screen 910. Selecting the Home Button will return the user to the main menu screen 300 of the travel planning resource mobile application.
(52) In reference to FIG. 18, depicted is an exemplary illustration of Activity Detail Expansion 910 in the mobile application. This is a direct output of selecting an item on the Itinerary/Agenda Screen 900. The Activity Detail Expansion 910 may include Activity Cost, Activity Location, other respective details, and Home Button 300. For Example, “Group Dinner, $60, Attire Classy Chic, URL: www.VIdining.com”. This does not limit the detail input to these factors. Selecting the Home Button will return the user to the main menu screen 300 of the travel planning resource mobile application.
(53) In reference to FIG. 19, illustrated is a block diagram process of the Itinerary/Agenda Function Process Flow. This process includes Select Agenda/Itinerary Screen 900. The Select Agenda/Itinerary Screen 900 includes Create Activity Screen 800 and View Agenda/Itinerary 900. Create Activity 800 allows an activity line item to be added to the Agenda/Itinerary. The View Agenda Screen 900 allows the activities from the Create Activity Screen 800 to be seen in a list format. The Select Activity Screen 900 includes The Activity Expansion Screen 910, which allows the viewing of the details for each activity. For Example, in the View Agenda form there are a list of two (2) activities “Whim Plantation Tour” and “Botanical Gardens Tour”. By selecting “Botanical Gardens Tour” the details may include “2:00 pm-4:00 pm, Attire: Comfortable, Details: Walk with water for hydration”.
(54) In reference to FIG. 20, depicted is an exemplary illustration of the group member log 1000 in the mobile application. The Group member log 1000 may include a Mute button, Add Member Button, a List of the Group members, and Home Button 300. Selecting the Home Button will return the user to the main menu screen 300 of the travel planning resource mobile application.
(55) The Mute Button may allow the user to turn off messages and notifications on the mobile device for the group that they are in.
(56) The Add member Button may allow the user to add participants to the group for travel planning Selecting this button may take the user to FIG. 21 Add Member Screen 1010. The list of the members in the group is reflective of all of the participants that have been invited to take part in the group travel. Selecting a participants name will navigate the user to Active Chat Log 1100.
(57) In reference to FIG. 21, depicted is an exemplary illustration of Add member screen 1010 in the mobile application. The group add member screen 1010 may include a Type a name or phone number field and Home Button 300. The Type a name, email, or phone number field allows the input of the name of a contact in your phone book, email address, or phone number. The selection of the phone number/email address or contact will make the group visible to the person synched with the contact or phone number/email address. This will then allow them to participate in-group travel planning Group travel planning includes the modification of the Itinerary/Agenda 900, Utilizing the Group Chat 1100, Budget Utilization 1240/1270/1250/1210/1230 and uploading pictures to the album 1300. Selecting the Home Button will return the user to the main menu screen 300 of the travel planning resource mobile application.
(58) In reference to FIG. 22, depicted is an exemplary illustration of an Active Chat Log screen 1100 in the mobile application. The messages either can be private communication between two users in the group or directed towards the entire group. The messages operate similar to text messages and other forms of instant messaging. The Active Chat log screen 1100 also includes a Home Button 300. Selecting the Home Button will return the user to the main menu screen 300 of the travel planning resource mobile application.
(59) In reference to FIG. 23, illustrated is a block diagram of the Group Chat Function process in the mobile application. The process includes the inputting of messages in the Chat Log 1100 by multiple users. The messages are then transmitted using the individual wireless carriers that each user utilizes for mobile phone service. These messages are then received in the mobile application server/database. Messages are then viewable by the group participants in the chat log 1100.
(60) In reference to FIG. 24, depicted is an exemplary illustration of the message center 1110 in the mobile application. The message center screen 1110 may be accessed by selecting the message center button on the Home screen 300. The message center 1110 may include a list of Active Chat Log Screens 1100 and a Home Button 300. Selecting the Home Button will return the user to the main menu screen 300 of the travel planning resource mobile application.
(61) In reference to FIG. 25, depicted is an exemplary illustration of Create Budget Line Item Screen 1200 in the mobile application. The Create Budget Line Item Screen 1200 may include a budget item field, Category field, amount field, Done Button, and Home Button 300. The budget item field will be inputted by the user as a reference title for the budget line item. The category field will be inputted by the user through selection of one of the pre-generated budget categories. In the event that the desired category is not an option, the user can manually input a desired category using a combination of letters and numbers. The amount field will be inputted by the user using a combination of numbers to reflect the cost associated with that line item. The done button will add the line item to FIG. 26 Budget Overview 1210. Selecting the Home Button will return the user to the main menu screen 300 of the travel planning resource mobile application.
(62) In reference to FIG. 26, depicted is an exemplary illustration of the Budget Over view 1210 in the mobile application. The budget overview 1210 includes an Overview Button, Create budget line item button, Make Payment Button, History Button, My View button, Home button, and list of the balance for all of the categories. The Overview Button may provide a visual summary of the total budget. The total budget is depicted as the amount that has been received towards the total cost. Additionally, the overview screen 1210 shows the present account balance broken down into categories. An example of the categories would include food, lodging, activities, etc. Selecting the Home Button will return the user to the main menu screen 300 of the travel planning resource mobile application.
(63) The Add Budget Line Item Button navigates the user to FIG. 25 Create Budget Line Item Screen 1200.
(64) The Make Payment Button navigates the user to FIG. 30 Payment Screen 1250.
(65) The History Button navigates the user to FIG. 28 Budget History Screen 1230.
(66) The My View button navigates the user to FIG. 29 Personal Budget View 1240.
(67) In reference to FIG. 27, depicted is an exemplary illustration of a Budget Expansion Screen 1220 in the mobile application. The Budget Expansion screen 1220 is the output of selecting one of the categories in FIG. 26 Budget Overview 1210. The budget expansion screen 1220 may include a list of paid items and unpaid items are seen in each category, the amount associated with each category, and the Home button 300. Selecting the Home Button will return the user to the main menu screen 300 of the travel planning resource mobile application.
(68) In reference to FIG. 28, depicted is an exemplary illustration of the Budget History Screen 1230 in the mobile application. The Budget History Screen 1230 may include an Overview Button, Create budget line item button, Make Payment Button, History Button, My View button, Home Button, a list of the transactions executed in that group. Selecting the Home Button will return the user to the main menu screen 300 of the travel planning resource mobile application.
(69) In reference to FIG. 29, depicted is an exemplary illustration of the Personal Budget View 1240 of the mobile application. The Personal Budget View 1240 may include an Overview Button, Create budget line item button, Make Payment Button, History Button, My View button, Home Button, and a list of the line items paid and unpaid by the user. Selecting the Home Button will return the user to the main menu screen 300 of the travel planning resource mobile application.
(70) In reference to FIG. 30, depicted is an exemplary illustration of the Make Payment Screen 1250 of the mobile application. The Make Payment Screen may include an Overview Button, Create budget line item button, Make Payment Button, History Button, Home Button, and My View button. The amount to be paid is inputted using the keypad by the user. The Make Payment Screen 1250 may provide categories for selection to allow the group participant to pay towards their trip. Selecting the Home Button will return the user to the main menu screen 300 of the travel planning resource mobile application. Selecting the Home Button will return the user to the main menu screen 300 of the travel planning resource mobile application.
(71) In reference to FIG. 31, depicted is an illustration of the Add Cash Screen 1260 in the mobile application. The Add Cash Screen 1260 may include a keypad for input of the quantity of funds to be paid to a Budget line item or to another user. Selecting the Home Button will return the user to the main menu screen 300 of the travel planning resource mobile application.
(72) In reference to FIG. 32, depicted is an illustration of a Virtual Card Screen 1270 in the mobile application. The Virtual Card Screen 1270 may include an Add Cash Button, Cash Out button, and Home Button 300. This feature is assigned to each user individually as well as to the travel group. For individual purposes, it allows users to transfer funds to each other and to manage their virtual account. For groups it allows the external payments to vendors on the group's behalf.
(73) The Add Cash Button will navigate the user to FIG. 31 Add Cash Screen 1260.
(74) The Cash Out Button will allow the user to withdraw the funds from the virtual account and transfer it to an external personal account.
(75) In reference to FIG. 33, illustrated is a block diagram process of Internal Virtual Card Payments in the mobile application. This process may include Select Budget 1210, Choose Category 1250, Add Cash 1260, and Submit Payment 1260.
(76) In reference to FIG. 34, illustrated is a block diagram process of the External Virtual Card payments in the mobile application. This process may include Select Virtual Card 1270, Navigate to External Source, Input Card Information, and Submit Payment.
(77) The External Source references the vendor that will be used to execute trip logistics. For example, the group chooses to use the Budget Car Rental Service to rent a hard top jeep for the US Virgin Islands trip. They would then make the reservation for the vehicle on the budget website. The Virtual Card Screen 1270 will be used to get the card information to enter on the Budget Car Rental website to complete the order. Once this is done an image of the reservation can be added to the Budget Expansion Screen 1220.
(78) All of the above features are applicable for individual usage as well. This would be considered a solo travel group through which the group creator would utilize the travel planning resource mobile application for organization of individual logistics. The budget utilization will still serve the purpose of financial organization.
(79) The terms and expressions stated in the specifications are used as terms of descriptions and are not intended for the purpose of limitation. The terms and expressions were not used with the intent of eliminating equivalent terms of the features shown or portions of the features shown. It is recognized that variations are possible within the scope of the travel planning resource mobile application.

What is claimed:

1) A travel planning resource mobile application, which serves as a system/method for exclusive communication & financial transactions relative to a single person or specific group of persons for travel purposes. The system consisting of: A travel planning resource mobile application to be installed on a mobile device via a mobile application store. Once downloaded the mobile application allows a user to obtain ownership of a created group/single electronic trip option through their user account. Their group can then be configured through locally generated content in the form of an itinerary, budget, photo album, etc. facilitated by the group's user(s).

2) The system in claim 1, where in the travel planning resource mobile application is further configured to allow users to create an account OR to add users/participants to an exclusive active group using either an email address, phone number, or social media account in the form of Facebook.

3) The system of claim 1, wherein the travel planning resource mobile application is further configured to allow the users to communicate through a chat log within the group by:
a. Typing Verbiage
b. Commenting on other persons statements directly
c. Reacting to another person's statement using pre-generated reactions

4) The system in claim 1, where in the travel planning resource mobile application is further configured to allow users to be labeled and take on specific roles as it pertains to trip coordination such as:
a. Event and Activity Planner
b. Hotel Finder
c. Group Coordinator
d. Trip Coordinator
e. Budget Coordinator

5) The system in claim 1, such that the travel planning resource mobile application contains an itinerary menu where each item on the itinerary menu can include details in the form of a description, picture, web link, attire, time, etc. which can be manipulated by any member of the group through adding, deleting, or editing.

6) The system in claim 1, such that the travel planning resource mobile application is further configured so that users can add or remove pictures/videos from multiple user created albums in the group pictures.

7) The system in claim 1, where in the travel planning resource mobile application is further configured to allow the trip coordinator group creator the ability to utilize budget functions.

8) The System in claim 7, where in the travel planning resource mobile application is further configured to allow the trip coordinator to accept payments toward the trip break down through general transactions, auto pay, or installations via credit/debit card, account information, venmo, cash app or PayPal.

9) The system in claim 8, where in the travel planning resource mobile application is further configured to compile all received funds into a temporary virtual account tied to a virtual debit card created alongside the group that is not accessible by anyone outside the group.

10) The system in claim 8, such that the trip coordinator or group coordinator can make the mass account information in the form of balances or transactions visible OR hidden from the entire group or select users for purposes of making transactions in the form of withdraws or payments to trip expenses. Only persons with access to the account can see the details and execute tasks.

11) The system in claim 8, such that each user/trip participant is able to see their unique balance view exclusive of the entire group budget and make payments directly towards that.

12) The system in claim 8, where in the travel planning resource mobile application is further configured to allow the user to make directed individual payments to other users/trip participants.

13) The system in claim 8, such that the users/trip participants can add or remove items to the budget breakdown.

14) The system of claim 8, such that will allow for remote communication between the trip creator and/or budget coordinator and financial entity to enable wire transactions for payments from the temporary account tied to the virtual debit card to allow direct payments to be made to the trip expenses and vendors without needing to export finances.

15) The system in claim 14, such that images of receipts obtained through payments of the trip expenses can be uploaded under a specific category for viewing by all group participants to allow for transparency & safety.

16) The system in claim 14, wherein the travel planning resource mobile application is further configured to prevent over drafting from the temporary account tied to the virtual debit card of any amount that surpasses the deposited amount by group participants.

17) The system in claim 1, where in the travel planning resource mobile application is further configured to allow users to delete the group after completion. This also dissolves the temporary account for transactions.

18) The system in claim 1, where in the travel planning resource mobile application is further configured to allow users to maintain the group for chat options or payment options post trip execution.

19) The system in claim 1, where in the travel planning resource mobile application is further configured to allow the saving of groups for further travel arrangements.

20) The system in claim 8, where in the travel planning resource mobile application is further configured to ensure safe completion of financial transactions even after the group is created.
